(19) United States
(12) Patent Application Publication
(10) Pub. No.: US 2021/0008752 A1
(43) Pub. Date: Jan. 14, 2021

(54) ADJUSTABLE MULTI-SECTION BLADE STRUCTURE FOR AUTOMATIC PLANER

(71) Applicant: Bor-Yann Chuang, TAICHUNG CITY (TW)

(72) Inventor: Bor-Yann Chuang, TAICHUNG CITY (TW)

(21) Appl. No.: 16/506,846

(22) Filed: Jul. 9, 2019

(51) Int. Cl. B27C 1/14

(52) U.S. Cl. CPC B27C 1/14

(57) ABSTRACT

An adjustable multi-section blade structure for an automatic planer includes a cutter shaft, a plurality of cutter holders, a plurality of cutters, and a blade calibration tool. The cutter shaft is a long cylinder. The cutter shaft has an outer annular surface and an axis. The cutter holders are arranged at substantially equiangular intervals around the outer annular surface of the cutter shaft. The cutter holders each have a fixing surface, a bearing surface, and an arcuate groove. The cutters are spaced apart from each other and disposed on the fixing surface. In addition to reducing the cutting load, the precision of the blade can be calibrated through the blade calibration tool to achieve an energy-saving effect.

### FIELD OF THE INVENTION

The present invention relates to a blade structure for an automatic planer, and more particularly to an adjustable multi-section blade structure for an automatic planer.

### BACKGROUND OF THE INVENTION

The cutter shaft structure of a conventional automatic planer includes a cutter shaft, a plurality of blades, and a plurality of cutter holders. The cutter shaft has an outer annular surface. The cutter holders are disposed at substantially equiangular intervals around the outer annular surface of the cutter shaft. Each blade is locked to a corresponding cutter holder by a plurality of positioning pins. The precision of the blade is maintained by the positioning pins, and the length of the blade is always the same as the length of the cutter holder.

However, when the automatic planer is used for cutting, the cutting load is large because the blade of the cutter holder is in the form of a whole piece. When the machine is rotated at a high speed, the machine must output more power to drive its rotation. The precision of the blade cannot be achieved after the blade is sharpened. As a result, the blade becomes dull and can no longer be sharpened. If the blade is damaged due to wear, the entire blade needs to be replaced, which increases the cost of replacing the components. Accordingly, the inventor of the present invention has devoted himself based on his many years of practical experiences to solve these problems.

### SUMMARY OF THE INVENTION

The primary object of the present invention is to provide an adjustable multi-section blade structure for an automatic planer to reduce the cutting load. When the blade becomes dull, it can be sharpened and calibrated. The precision of the blade can be maintained without replacing the entire blade. In addition, the cost of replacing the components can be reduced, and the energy-saving effect can be achieved.

In order to achieve the objects, an adjustable multi-section blade structure for an automatic planer is provided. The adjustable multi-section blade structure comprises a cutter shaft, a plurality of cutter holders, a plurality of cutters, and a blade calibration tool. The cutter shaft is a long cylinder. The cutter shaft has an outer annular surface. Either end of the cutter shaft is provided with a transmission rod. The cutter holders are disposed on the outer annular surface of the cutter shaft. The cutter holders are arranged at substantially equiangular intervals around the outer annular surface of the cutter shaft. The cutter holders each have a fixing surface and a bearing surface. The fixing surface is provided with a plurality of first fixing units. The cutters are spaced apart from each other and disposed on the fixing surface. The cutters each include a blade, a pressing plate, a positioning member, and a fixing member. The blade has a first positioning unit and a second fixing unit. The pressing plate has a second positioning unit and a third fixing unit. The positioning member is inserted through the first positioning unit and the second positioning unit to combine the blade and the pressing plate into each of the cutters. The fixing member is inserted through the second fixing unit and the third fixing unit to screw each of the cutters to the fixing surface. The blade calibration tool includes a main body. The main body has a first recess. A bottom of the first recess is provided with a second recess. A bottom of the second recess has an opening. The bottom of the second recess is provided with a pair of positioning posts at two sides of the opening. The main body has a first positioning surface close to the first recess. The main body has a second positioning surface close to the second recess. When the cutters need to be calibrated, the blade and the pressing plate are respectively placed in the first recess and the second recess, the pressing plate abuts against the second positioning surface, and the blade abuts against the first positioning surface for calibrating the precision of the cutters. The opening is configured for the positioning member to secure the blade and the pressing plate together.

As to the adjustable multi-section blade structure for the automatic planer provided by the present invention, the cutters are spaced apart from each other and disposed along the axis of the cutter shaft to reduce the cutting load. After the blade is sharpened, it can be calibrated by the blade calibration tool to maintain the precision of the blade without replacing the entire blade. This way can reduce an unnecessary waste. In addition, the cost of replacing the components can be reduced, and the energy-saving effect can be achieved.

### BRIEF DESCRIPTION OF THE DRAWINGS

FIG. 1 is a perspective view in accordance with a preferred embodiment of the present invention;

FIG. 2 is a partial exploded view in accordance with the preferred embodiment of the present invention;

FIG. 3 is a side view in accordance with the preferred embodiment of the present invention;

FIG. 4 is an exploded view of the blade calibration tool when in use in accordance with the preferred embodiment of the present invention;

FIG. 5 is a perspective view of the blade calibration tool when in use in accordance with the preferred embodiment of the present invention;

FIG. 6 is a cross-sectional view of FIG. 5; and

FIG. 7 is a side view in accordance with the preferred embodiment of the present invention, showing the cutters after being sharpened and calibrated.

### DETAILED DESCRIPTION OF THE PREFERRED EMBODIMENTS

Embodiments of the present invention will now be described, by way of example only, with reference to the accompanying drawings.

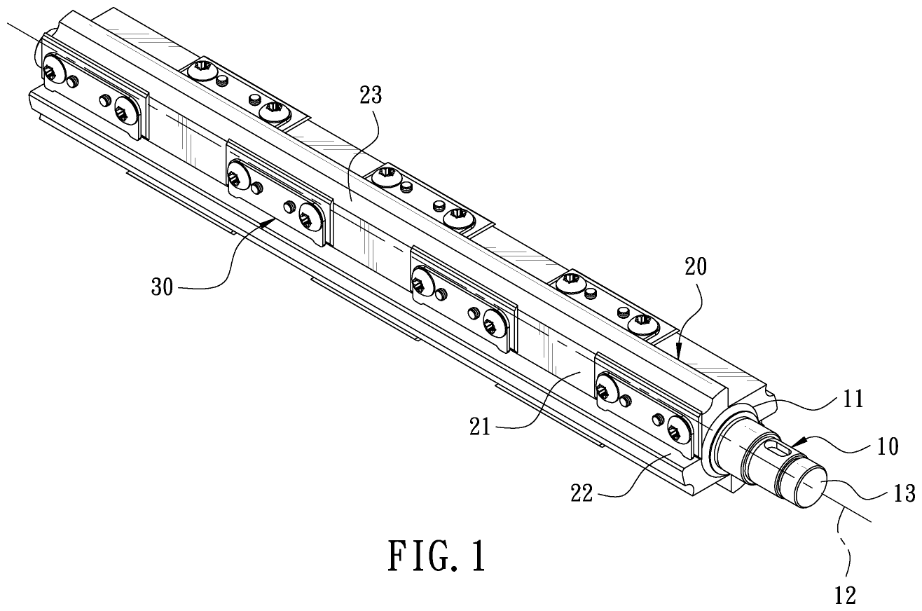

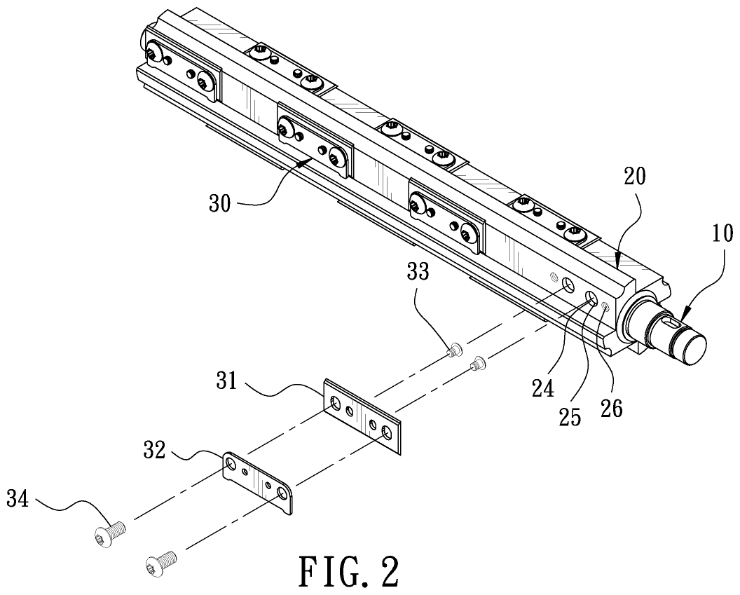

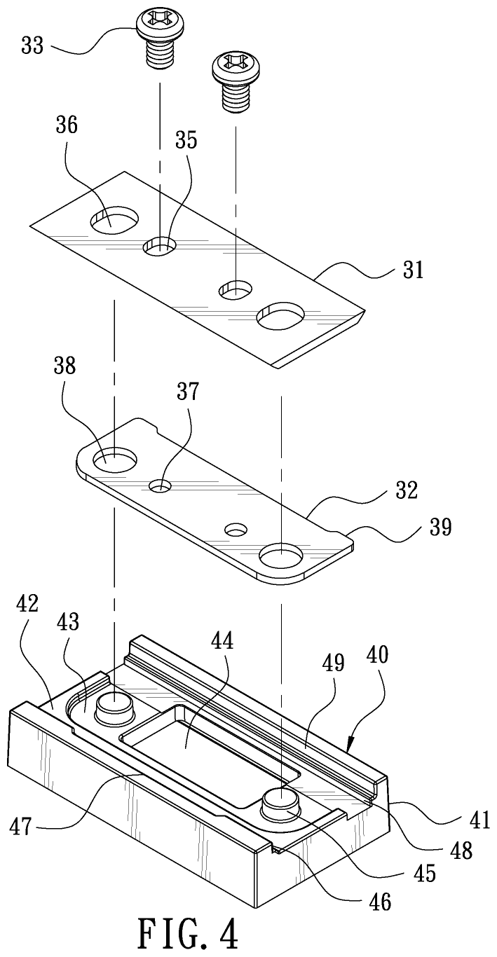

FIG. 1 is a perspective view in accordance with a preferred embodiment of the present invention. FIG. 2 is a partial exploded view in accordance with the preferred embodiment of the present invention. FIG. 4 is an exploded view of a blade calibration tool when in use in accordance with the preferred embodiment of the present invention. The present invention discloses an adjustable multi-section blade structure for an automatic planer, comprising a cutter shaft 10, a plurality of cutter holders 20, a plurality of cutters 30, and a blade calibration tool 40.

The cutter shaft 10 is a long cylinder. The cutter shaft 10 has an outer annular surface 11 and an axis 12. Either end of the cutter shaft 10 is provided with a transmission rod 13.

In this embodiment of the present invention, the number of the cutter holders 20 is four. The cutter holders 20 are disposed on the outer annular surface 11 of the cutter shaft 10. The cutter holders 20 are arranged at substantially equiangular intervals around the outer annular surface 11 of the cutter shaft 10. Each of the cutter holders 20 has a fixing surface 21, a bearing surface 22, and an arcuate groove 23. The fixing surface 21 is provided with a plurality of first fixing units 24. In this embodiment of the present invention, each of the first fixing units 24 includes two limiting holes 25 and two screw holes 26. The two limiting holes 25 are spaced apart from each other. The two screw holes 26 are spaced apart from each other and located at two sides of the two limiting holes 25. The fixing surface 21 is perpendicular to the bearing surface 22. The bearing surface 22 is disposed at one side of the fixing surface 21. The arcuate groove 23 is disposed at another side of the fixing surface 21.

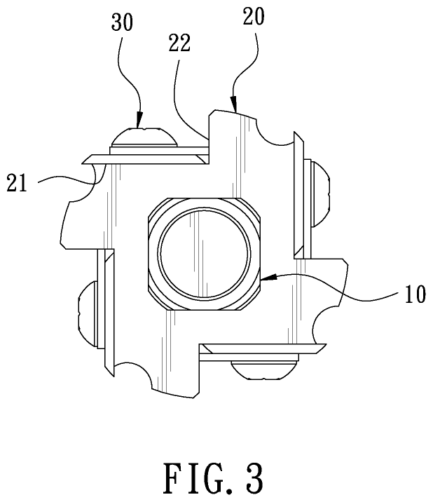

Referring to FIG. 3, the cutters 30 are spaced apart from each other along the axis 12 and disposed on the fixing surface 21, and the cutters 30 simultaneously abut against the bearing surface 22 adjacent to the fixing surface 21. The cutters 30 of each fixing surface 21 and the cutters 30 of the adjacent fixing surface 21 are arranged in a staggered manner. Each of the cutters 30 includes a blade 31, a pressing plate 32, a positioning member 33, and a fixing member 34. The blade 31 has a first positioning unit 35 and a second fixing unit 36. The first positioning unit 35 and the second fixing unit 36 are a plurality of perforations in an elliptical shape, and may be arranged in a bilateral or spaced manner. In this embodiment of the present invention, the first positioning unit 35 and the second fixing unit 36 are two perforations, respectively. The first positioning unit 35 is spaced apart and located close to the middle of the blade 31. The second fixing unit 36 is spaced apart and located at two sides of the first positioning unit 35. The pressing plate 32 has a second positioning unit 37, a third fixing unit 38, and two legs 39. The second positioning unit 37 and the third fixing unit 38 are a plurality of perforations in a circular shape, and may be arranged in a bilateral or spaced manner. In this embodiment of the present invention, the second positioning unit 37 and the third fixing unit 38 are two perforations, respectively. The second positioning unit 37 is spaced apart and located close to the middle of the pressing plate 32. The third fixing unit 38 is disposed at two sides of the second positioning unit 37. The two legs 39 are disposed on two sides of the underside of the pressing plate 32. The positioning member 33 and the fixing member 34 are a plurality of screws. In this embodiment of the present invention, the positioning member 33 and the fixing member 34 are two screws, respectively. The positioning member 33 is inserted through the first positioning unit 35 and the second positioning unit 37 to combine the blade 31 and the pressing plate 32 into the cutter 30. The fixing member 34 is inserted through the second fixing unit 36 and the third fixing unit 38 to screw the cutter 30 to the fixing surface 21.

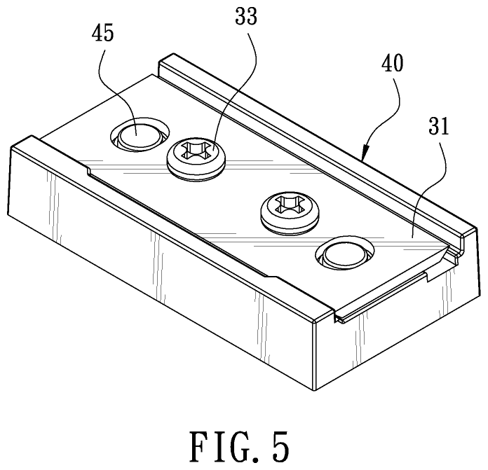

The blade calibration tool 40, referring to FIG. 5, includes a main body 41 which is generally rectangular. The main body 41 has a first recess 42. The length and the width of the first recess 42 are greater than the length and the width of the blade 31. The bottom of the first recess 42 is provided with a second recess 43. The length and the width of the second recess 43 are greater than the length and the width of the pressing plate 32. The bottom of the second recess 43 has a rectangular opening 44. The bottom of the second recess 43 is provided with a pair of positioning posts 45 at two sides of the opening 44. The main body 41 has a first positioning surface 46 close to the first recess 42. The first positioning surface 46 is provided with a first limiting groove 47. The main body 41 has a second positioning surface 48 close to the second recess 43. The second positioning surface 48 is provided with a second limiting groove 49.

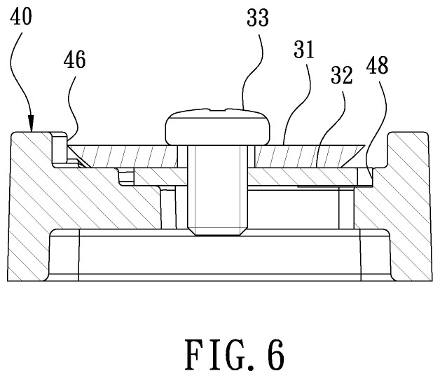

Referring to FIG. 4 to FIG. 6, after the automatic planer is used for a period of time, the blade 31 becomes dull or is not sharp. When the blade 31 is sharpened, the width of the blade 31 will be changed, so that it is necessary to place the blade 31 and the pressing plate 32 of the cutter 30 on the blade calibration tool 40 for calibration. First, the fixing member 34 is unscrewed to disengage the cutter 30 from the fixing surface 21, and the positioning member 33 is unscrewed to separate the blade 31 and the pressing plate 32 from each other. After that, the pressing plate 32 is placed in the second recess 43 of the blade calibration tool 40, and the two positioning posts 45 are respectively inserted through the third fixing unit 38, so that the two legs 39 respectively abut against the second positioning surface 48 and the pressing plate 32 is confined in the second recess 43. Then, the blade 31 is placed in the first recess 42 of the blade calibration tool 40 and is attached to the pressing plate 32, so that the two positioning posts 45 are inserted through the second fixing unit 36 and the third fixing unit 38, respectively. The edge of the blade 31 abuts against the first positioning surface 46 to confine the blade 31 in the first recess 42, and the opening 44 allows the positioning member 33 to pass through the first positioning unit 35 and the second positioning unit 37. At this time, the threaded portion of the positioning member 33 is located in the opening 44, whereby the opening 44 is configured for the positioning member 33 to secure the blade 31 and the pressing plate 32 together.

It is worth mentioning that because there is a gap between the pressing plate 32 and the second recess 43, the pressing plate 32 can be pushed toward the second positioning surface 48 through the gap, so that the two legs 39 respectively abut against the second positioning surface 48. There is a gap between the blade 31 and the first recess 42. The blade 31 is pushed toward the first positioning surface 46 through the second limiting groove 49. At this time, the blade 31 can be accurately positioned on the first positioning surface 46 through the first limiting groove 47 to reduce the contact area. When the blade 31 is moved, the second fixing unit 36 in an elliptical shape provides a movement range for the blade 31.

Referring to FIG. 2 again, after the blade 31 is calibrated, the blade 31 and the pressing plate 32 that are secured together are removed from the blade calibration tool 40 and placed on the fixing surface 21 of the cutter holder 20. The positioning members 33 are confined in the limiting holes 25, and the legs 39 of the pressing plate 32 abut against the bearing surface 22. Then, the fixing member 34 screws the blade 31 and the pressing plate 32 to the fixing surface 21, and the fixing member 34 is fixed to the screw hole 26 to complete the assembly of the cutter 30.

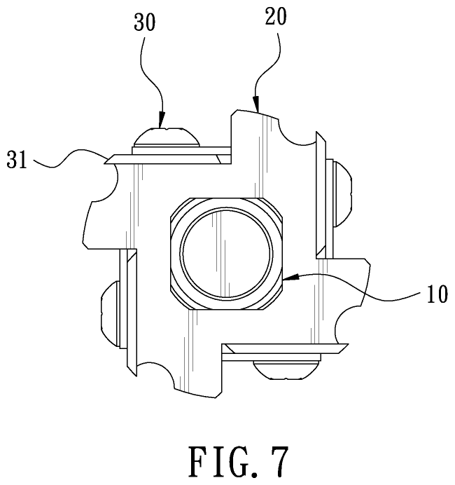

It is worth mentioning that the overall length of the blade 31 after being sharpened is shortened. As shown in FIG. 7, when the blade 31 and the pressing plate 32 are placed on the blade calibration tool 40, because the length and the width of the first recess 42 are greater than the length and the width of the blade 31, and the length and width of the second recess 43 are greater than the length and width of the pressing plate 32, the first recess 42 and the second recess 42 provide a movement space for the blade 31 and the pressing plate 32. The first positioning unit 35 and the second positioning unit 36 are a plurality of perforations in an elliptical shape to provide a movement range for the blade 31 and the pressing plate 32. After the blade 31 is sharpened many times, the cutter 30 still maintains its precision through the cutter calibration tool 40.

The first positioning surface 46 is provided with the first limiting groove 47, so that the edge of the blade 31 can be attached to the first positioning surface 46. The second positioning surface 48 is provided with the second limiting groove 49 for the user to push the blade 31 toward the first positioning surface 46. The operation is convenient and fast.

When one of the blades 31 is damaged or worn, it is only necessary to sharpen and calibrate the blade 31 to reduce an unnecessary waste. Since the blades 31 are arranged at intervals on each fixing surface 21, the cutting load can be reduced, thereby achieving an energy-saving effect.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An adjustable multi-section blade structure for an automatic planer, comprising:
a cutter shaft, the cutter shaft being a long cylinder, the cutter shaft having an outer annular surface, either end of the cutter shaft being provided with a transmission rod;
a plurality of cutter holders, the cutter holders being disposed on the outer annular surface of the cutter shaft, the cutter holders being arranged at substantially equiangular intervals around the outer annular surface of the cutter shaft, the cutter holders each having a fixing surface and a bearing surface, the fixing surface being provided with a plurality of first fixing units;
a plurality of cutters, the cutters being spaced apart from each other and disposed on the fixing surface, the cutters each including a blade, a pressing plate, a positioning member and a fixing member, the blade has a first positioning unit and a second fixing unit, the pressing plate having a second positioning unit and a third fixing unit, the positioning member being inserted through the first positioning unit and the second positioning unit to combine the blade and the pressing plate into each of the cutters, the fixing member being inserted through the second fixing unit and the third fixing unit to screw each of the cutters to the fixing surface;
a blade calibration tool, including a main body, the main body having a first recess, a bottom of the first recess being provided with a second recess, a bottom of the second recess having an opening, the bottom of the second recess being provided with a pair of positioning posts at two sides of the opening, the main body having a first positioning surface close to the first recess, the main body having a second positioning surface close to the second recess;
wherein when the cutters need to be calibrated, the blade and the pressing plate are respectively placed in the first recess and the second recess, the pressing plate abuts against the second positioning surface, and the blade abuts against the first positioning surface for calibrating the precision of the cutters.

2. The adjustable multi-section blade structure as claimed in claim 1, wherein the fixing surface is perpendicular to the bearing surface, and the bearing surface is disposed at one side of the fixing surface.

3. The adjustable multi-section blade structure as claimed in claim 1, wherein the cutter holders each has an arcuate groove, and the arcuate groove is disposed at another side of the fixing surface.

4. The adjustable multi-section blade structure as claimed in claim 1, wherein the first positioning unit and the second fixing unit are a plurality of perforations in an elliptical shape; the second positioning unit and the third fixing unit are a plurality of perforations in a circular shape.

5. The adjustable multi-section blade structure as claimed in claim 1, wherein the pressing plate further includes two legs, and the two legs are disposed on two sides of an underside of the pressing plate, respectively.

6. The adjustable multi-section blade structure as claimed in claim 1, wherein the main body has a rectangular shape, and the opening has a rectangular shape.

7. The adjustable multi-section blade structure as claimed in claim 1, wherein the first positioning surface is provided with a first limiting groove, and the second positioning surface is provided with a second limiting groove.

8. The adjustable multi-section blade structure as claimed in claim 1, wherein the first recess has a width greater than that of the blade, and the second recess has a width greater than that of the pressing plate.
